(19) United States
(12) Patent Application Publication
(10) Pub. No.: US 2011/0156656 A1
(43) Pub. Date: Jun. 30, 2011

(54) OVERCHARGE PROTECTION CIRCUIT, BATTERY PACK, AND CHARGING SYSTEM

(76) Inventor: Go Saito, Osaka (JP)

(21) Appl. No.: 13/000,565

(22) PCT Filed: Nov. 17, 2009
(86) PCT No.: PCT/JP2009/006143

§ 371 Date: Dec. 21, 2010

(30) Foreign Application Priority Data
Aug. 26, 2009 (JP) 2009-195267

(51) Int. Cl. H02J 7/04

(52) U.S. Cl. 320/134; 320/162

(57) ABSTRACT

An overcharge protection circuit includes: a voltage detection portion which detects a terminal voltage of a secondary battery; and a control portion, having a normal state in which the secondary battery can be charged, a judgment execution state in which judgement as to whether the secondary battery is in an overcharged state is performed, and a first charging prohibition state in which charging of the secondary battery is prohibited, wherein in the normal state, when a terminal voltage detected by the voltage detection portion exceeds a first overcharge detection voltage set in advance as a voltage at which charging of the secondary battery is to be prohibited, the control portion transitions to the judgment execution state, in the judgment execution state, when an accumulated value, after the judgment execution state is established, of a time interval during which the terminal voltage detected by the voltage detection portion exceeds the first overcharge detection voltage, exceeds a first reference time set in advance, the control portion transitions to the first charging prohibition state, and in the judgment execution state, when the terminal voltage detected by the voltage detection portion falls below a judgment cancellation voltage lower than the first overcharge detection voltage, the control portion transitions to the normal state and enables charging of the secondary battery.

### TECHNICAL FIELD

This invention relates to an overcharge protection circuit which protects a secondary battery from overcharging, and to a battery pack and charging system comprising such a circuit.

### BACKGROUND ART

When secondary batteries such as lithium-ion secondary batteries and nickel-hydrogen secondary batteries are overcharged to above the full-charge voltage, there are concerns that characteristics may be degraded and safety may be diminished. Hence charging circuits to charge secondary batteries attempt to control charging such that overcharging of secondary batteries does not occur by detecting when full charging of a secondary battery occurs and stopping the charging.

However, if erroneous operation or malfunction of a charging circuit occurs, the secondary battery can be overcharged, and there are concerns that the secondary battery characteristics may be degraded or that safety may be diminished. Hence a charge protection circuit, which detects overcharging of a secondary battery and stops charging of the secondary battery to protect the secondary battery from overcharging, is provided in equipment and battery packs using secondary batteries (for example, Patent Documents 1 to 3).

FIG. 9 is a state transition diagram used to explain operation of an overcharge protection circuit of the prior art. Further, FIG. 10 is a waveform diagram used to explain operation of an overcharge protection circuit when performing constant-current charging of a secondary battery. First, the overcharge protection circuit is normally in a normal state enabling charge/discharge of the secondary battery (state S101). Here, when constant-current charging of the secondary battery is begun at time T101 in FIG. 10, the battery voltage of the secondary battery rises.

And, when the battery voltage exceeds an overcharge detection voltage V1 (time T102), a timer circuit begins time measurement, and the timer value rises. And, when the timer value reaches a threshold time t101, the overcharge protection circuit transitions from the state S101 to a state S102 indicating an overcharged state of the secondary battery. In the state S102, charging of the secondary battery is prohibited, a charging current ceases to flow to the secondary battery, and the battery voltage declines (time T103). In this way, the secondary battery is protected from overcharging.

And, because discharge is possible even in the state S102, when the secondary battery discharges and a state in which the battery voltage has fallen below a prohibition cancellation voltage V2 continues for the period of a threshold time t102, there is a transition to the normal state (state 101), and charging of the secondary battery is again made possible.

A pulse charging method, in which a charging current is turned on and off in pulse fashion while performing charging, is known as a method of charging a secondary battery. FIG. 11 is a waveform diagram used to explain the overcharge protection operation of FIG. 9 in a case in which pulse charging is performed.

First, at time T111, supply of a pulse-form charging current to the secondary battery is begun. In FIG. 11, the time during which the charging current is flowing is ton, and the time during which the charging current is stopped is toff. And, when the battery voltage exceeds the overcharge detection voltage V1 (time T112), the timer circuit begins time measurement, and the timer value rises.

Here, before the timer value reaches t101, when the time ton has elapsed from the time T111, the charging current becomes zero, and the battery voltage declines and falls below the overcharge detection voltage V1. Then, the timer is reset, the state S101 is maintained without change, and there is no transition to state S102, so that pulse charging is not prohibited.

And, when time toff has elapsed from the time T113, the charging current again flows, the battery voltage exceeds the overcharge detection voltage V1 (time T114), the timer circuit begins time measurement, and the timer value rises. Here, if the time ton is shorter than the threshold time t101, the time ton always elapses before the timer value reaches t101, the charging current becomes zero, and the battery voltage declines and falls below the overcharge detection voltage V1. Then, the timer is reset, the state S101 is maintained without change, and there is no transition to state S102, so that pulse charging is not prohibited (time T115).

Further, in pulse charging, the charging pulses are controlled such that as charging of the secondary battery proceeds the time ton is made shorter. That is, the time ton is variably controlled, and so the threshold time t101 cannot be set in advance to a value shorter than the time ton.

Subsequently, the operation of time T115 to time T114 to time T115 . . . is continued, and pulse charging is continued without change, without prohibiting charging of the secondary battery, and so there is the problem that the secondary battery cannot be protected from overcharging.

### CITATION LIST

### Patent Literature

Patent Document 1: Japanese Patent Application Laid-open No. H5-111177
Patent Document 2: Japanese Patent Application Laid-open No. H8-186940
Patent Document 3: Japanese Patent Application Laid-open No. H11-89099

### SUMMARY OF INVENTION

An object of this invention is to provide an overcharge protection circuit, battery pack, and charging system which can reduce the concern that a secondary battery cannot be protected from overcharging, even during pulse charging.

An overcharge protection circuit according to a first aspect of the invention includes: a voltage detection portion which detects the terminal voltage of a secondary battery; and a control portion, having a normal state in which the secondary battery can be charged, a judgment execution state in which judgement as to whether the secondary battery is in an overcharged state is performed, and a first charging prohibition state in which charging of the secondary battery is prohibited, wherein in the normal state, when a terminal voltage detected by the voltage detection portion exceeds a first overcharge detection voltage set in advance as a voltage at which charging of the secondary battery is to be prohibited, the control portion transitions to the judgment execution state, in the judgment execution state, when an accumulated value, after the judgment execution state is established, of a time interval during which the terminal voltage detected by the voltage detection portion exceeds the first overcharge detection voltage, exceeds a first reference time set in advance, the control portion transitions to the first charging prohibition state, and in the judgment execution state, when the terminal voltage detected by the voltage detection portion falls below a judgment cancellation voltage lower than the first overcharge detection voltage, the control portion transitions to the normal state and enables charging of the secondary battery.

By means of this configuration, in addition to a normal state in which a secondary battery can be charged and a first charging prohibition state in which charging of the secondary battery is prohibited, the control portion can enter a judgment execution state in which judgment as to whether the secondary battery is in an overcharged state is performed. And, in the normal state, when the terminal voltage of the secondary battery exceeds the first overcharge detection voltage, the control portion transitions to the judgment execution state. Upon entering the judgment execution state, so long as the terminal voltage of the secondary battery does not fall below the judgment cancellation voltage, which is lower than the first overcharge detection voltage, there is no transition to the normal state, so that even if charging pulses in pulse charging are turned off, the judgment execution state is maintained. And, even when the charging pulse is repeatedly turned on and off in pulse charging, while the judgment execution state is maintained, the time interval during which the terminal voltage of the secondary battery exceeds the first overcharge detection voltage is accumulated, so that when pulse charging is continued this accumulated value increases, and at some time exceeds the first reference time. When this occurs the control portion transitions to the first charging prohibition state, and charging of the secondary battery is prohibited, so that even in pulse charging, the concern that the secondary battery cannot be protected from overcharging can be reduced.

Further, a battery pack according to an aspect of this invention includes: the above-described overcharge protection circuit; and the secondary battery.

By means of this configuration, even when pulse charging of the battery pack comprising the overcharge protection circuit is performed, the concern that the secondary battery cannot be protected from overcharging can be reduced.

Further, a charging system according to one aspect of this invention includes: the above-described overcharge protection circuit; and a charging portion which performs pulse charging of the second battery by periodically supplying, in pulse form, a charging current set in advance.

By means of this configuration, in a charging system comprising a charging portion which performs pulse charging of a secondary battery, the concern that the secondary battery cannot be protected from overcharging can be reduced.

### BRIEF DESCRIPTION OF THE DRAWINGS

FIG. 1 is a block diagram showing one example of the configuration of a battery pack comprising a battery protection circuit which is one example of an overcharge protection circuit of an embodiment of this invention, and of a charging system.

FIG. 2 is a state transition diagram showing one example of operation in a case in which a control portion, as an overcharge protection circuit, does not include a second charging prohibition state.

FIG. 3 is a waveform diagram to explain operation of a battery protection circuit in a case in which pulse charging is not performed.

FIG. 4 is an explanatory diagram to explain operation of a battery protection circuit in a case in which the second reference time is less than the charging prohibition time.

FIG. 5 is a state transition diagram for a case in which, in the state transition diagram shown in FIG. 2, the condition for transition from the judgment execution state to the first charging prohibition state is made “a case in which the time during which the terminal voltage is below the first overcharge detection voltage continues and exceeds the second reference time”.

FIG. 6 is an explanatory diagram to explain a case in which the operation shown by the state transition diagram of FIG. 5 is performed in a case in which the second reference time is less than the charging prohibition time.

FIG. 7 is a state transition diagram showing one example of operation in a case in which, in the battery protection circuit shown in FIG. 1, the control portion includes a second charging prohibition state.

FIG. 8 is a waveform diagram to explain operation of a battery protection circuit based on the state transition diagram of FIG. 7, in a case in which pulse charging is performed.

FIG. 9 is a state transition diagram to explain operation of an overcharge protection circuit of the prior art.

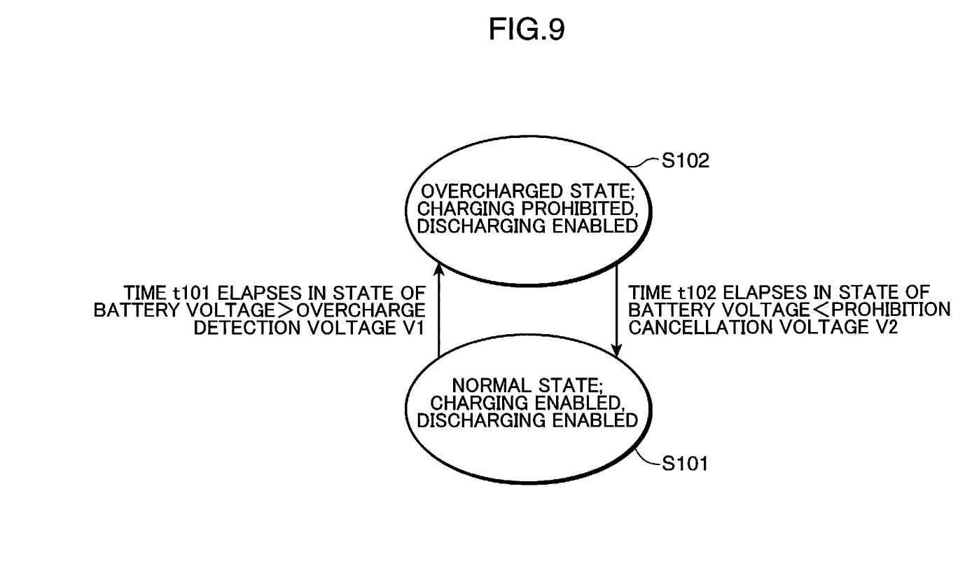

FIG. 10 is a waveform diagram to explain operation of the overcharge protection circuit shown in FIG. 9 in a case in which constant-current charging of a secondary battery is performed.

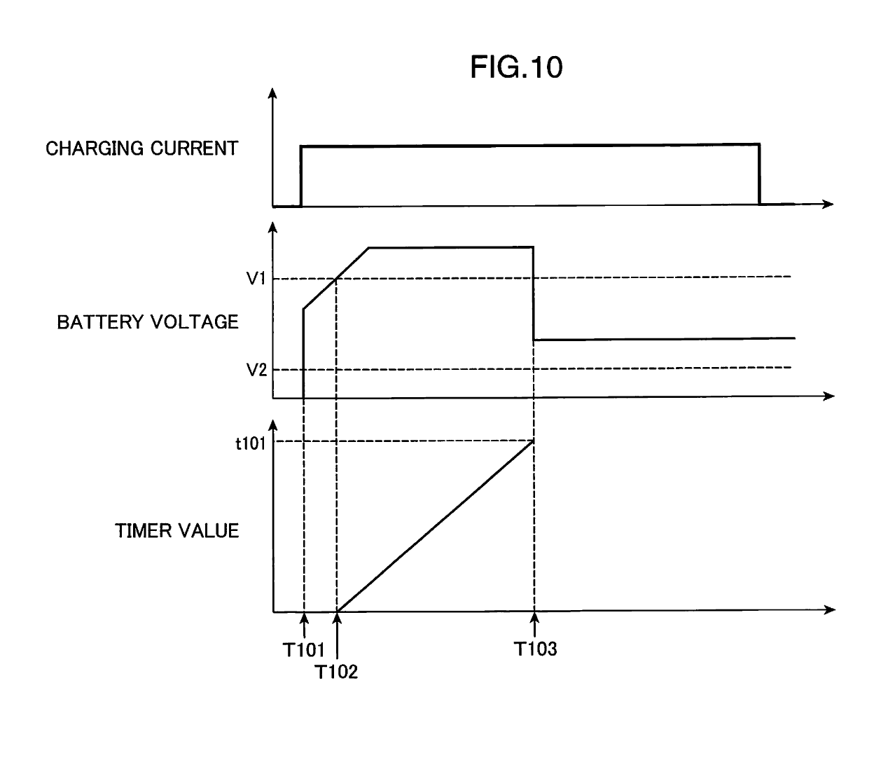

FIG. 11 is a waveform diagram to explain operation of the overcharge protection circuit shown in FIG. 9 in a case in which pulse charging is performed.

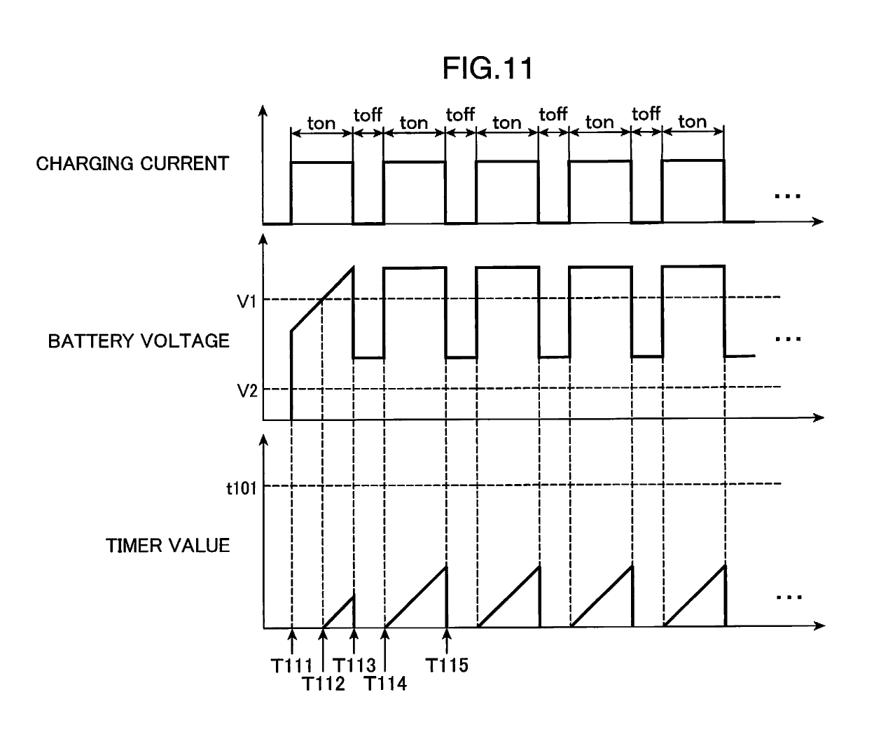

### DESCRIPTION OF EMBODIMENTS

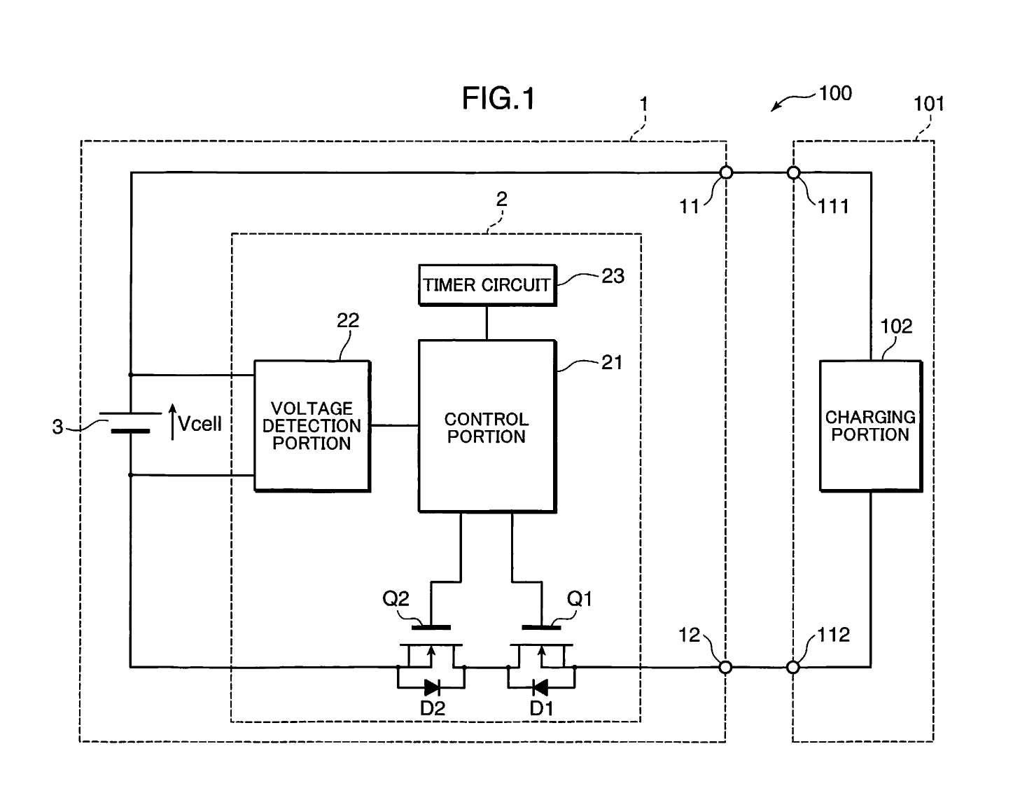

Below, an embodiment of the invention is explained based on the drawings. In the drawings, configurations to which the same symbol is assigned are the same, and explanations thereof are omitted. FIG. 1 is a block diagram showing an example of the configuration of a battery pack comprising a battery protection circuit which is one example of an overcharging protection circuit of an embodiment of this invention, and of a charging system.

The charging system 100 shown in FIG. 1 comprises a battery pack 1 and charging device 101 which are connected. The charging device 101 comprises a charging portion 102, connection terminal 111 connected to the positive-electrode side of the charging portion 102, and connection terminal 112 connected to the negative-electrode side of the charging portion 102. The battery pack 1 comprises a battery protection circuit 2, secondary battery 3, and connection terminals 11 and 12.

Further, the battery protection circuit 2 is configured comprising a control portion 21, voltage detection portion 22, timer circuit 23, switching elements Q1 and Q2, and diodes D1 and D2. The control portion 21, voltage detection portion 22, and timer circuit 23 are for example configured as an integrated circuit.

The battery pack 1 is for example connected to a portable telephone set, digital camera, portable personal computer, electric automobile, hybrid car, or to various other battery-driven equipment or devices, and is a battery pack which supplies electric power.

The charging portion 102 is a power supply circuit which generates a charging current for the battery pack 1 from for example a commercial power supply voltage; for example, electric power generation devices which generate electric power from such natural energy as sunlight, wind power, or hydraulic power, or electric power generation devices which generate electric power using the power of an internal combustion engine or similar, may be used.

A charging system 100 is not necessary limited to a configuration in which a battery pack 1 and charging device 101 can be separated, and a single battery protection circuit 2 may be configured for an entire charging system 100. Further, a battery protection circuit 2 may be divided between a battery pack 1 and a charging device 101. Further, a battery protection circuit 2 is not limited to the example of incorporation in a battery pack. For example, a battery protection circuit 2 may be provided in battery-driven equipment or devices as described above, or a battery protection circuit 2 may be provided in a charging device 101 which charges a secondary battery 3.

The secondary battery 3 is configured using various secondary batteries, such as for example lithium ion secondary batteries or nickel hydrogen secondary batteries, or similar. The secondary battery 3 may be a unit cell, or may be a battery module combining a plurality of secondary batteries. The voltage values described below are examples of voltage values for a case in which the secondary battery 3 is configured from a unit cell of a lithium ion secondary battery. When the secondary battery 3 is configured by connecting in series a plurality of cells, the voltage value obtained by multiplying by the number of series-connected cells is used for the voltage values of the examples below.

The connection terminals 11 and 12 are electrodes, connectors, or similar which can be connected to battery driving equipment, devices, chargers, and similar. The connection terminal 11 is connected to the positive electrode of the secondary battery 3. The connection terminal 12 is connected to the negative electrode of the secondary battery 3 via the switching elements Q1 and Q2.

And, when the battery pack 1 is mounted on the charging device 101, the connection terminal 11 and connection terminal 111, and the connection terminal 12 and the connection terminal 112 are respectively connected, so that charging current output from the charging portion 102 is supplied to the secondary battery 3 via the switching elements Q1 and Q2.

As the switching elements Q1 and Q2, various switching elements can be used; for example, FETs (Field Effect Transistors) are used. A parasitic diode D1 is formed between the source and drain of the switching element Q1, in the direction with the anode on the side of the connection terminal 12. And, a parasitic diode D2 is formed between the source and the drain of the switching element Q2, in the direction with the anode on the side of the secondary battery 3.

The gates of the switching elements Q1 and Q2 are connected to the battery protection circuit 2. And, the switching elements Q1 and Q2 are turned on and off according to control signals from the battery protection circuit 2. By this means, when the switching element Q1 (switching element for charging) is turned off, only charging of the secondary battery 3 is prohibited. Further, when the switching element Q2 (switching element for discharge) is turned off, only discharging of the secondary battery 3 is prohibited.

The voltage detection portion 22 detects the terminal voltage Vcell of the secondary battery 3. As the voltage detection portion 22, for example a comparator, error amplifier, analog digital converter, or various other voltage detection circuits can be used.

The timer circuit 23 measures the times of a first reference time t1, second reference time t2, third reference time t3, fourth reference time t4, and fifth reference time t5, described below. The timer circuit 23 may for example be an analog timer such as a multivibrator or similar, or may be a digital timer such as a PTM (Programmable Timer Module) or similar. Further, timer circuits measuring the times of the first reference time t1 (accumulated time ta), second reference time t2, third reference time t3, fourth reference time t4 (cumulative time ts), and fifth reference time t5, may be respectively comprised.

The control portion 21 may for example be configured using a state machine and a logic circuit, or may for example be configured using a microcomputer. The control portion 21 causes the switching element Q2 to be turned on and enables discharge of the secondary battery 3 when for example the terminal voltage Vcell detected by the voltage detection portion 22 exceeds a discharging prohibition voltage Voff set in advance in order to prevent overdischarge of the secondary battery 3, and causes the switching element Q2 to be turned off and prevents degradation of the secondary battery 3 due to overdischarge when the terminal voltage Vcell becomes equal to or less than the discharging prohibition voltage Voff.

Further, the control portion 21, as an overcharge protection circuit, has a normal state S1 to enable charging of the secondary battery 3, a judgment execution state S2 to judge whether the secondary battery 3 is in an overcharged state, and a first charging prohibition state S3 and second charging prohibition state S4 to prohibit charging of the secondary battery 3. The normal state S1, judgment execution state S2, first charging prohibition state S3, and second charging prohibition state S4 are for example obtained by means of states of a state machine, on/off states of logic gates, on/off states of flip-flop circuits, or the states of execution of a program by a microcomputer, or similar.

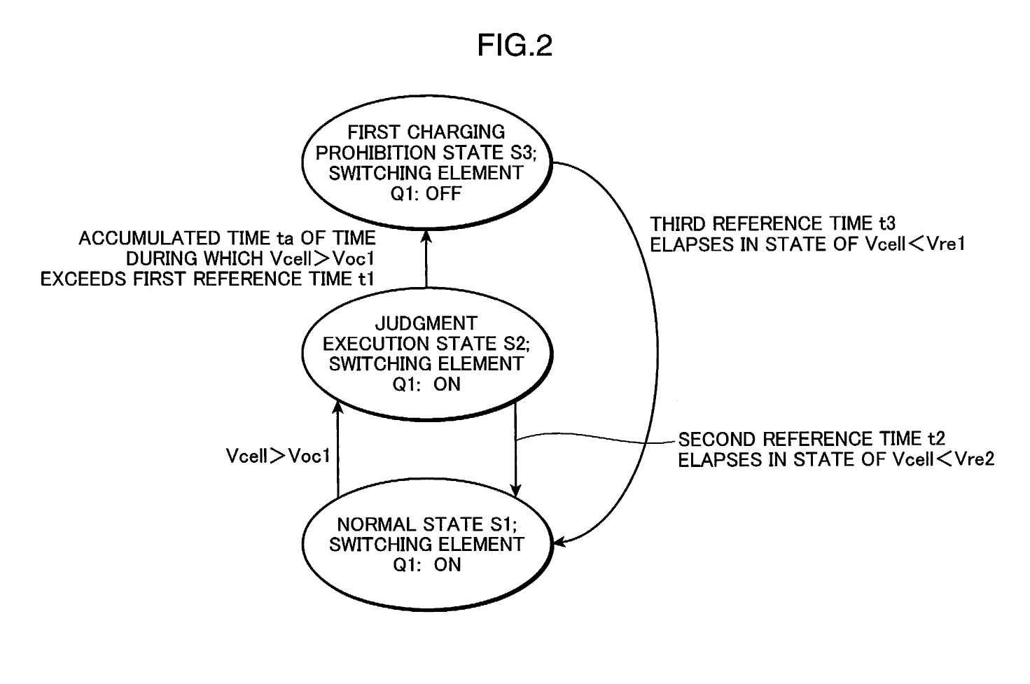

FIG. 2 is a state transition diagram showing, as reference, one example of operation in a case in which a control portion 21 does not include a second charging prohibition state S4.

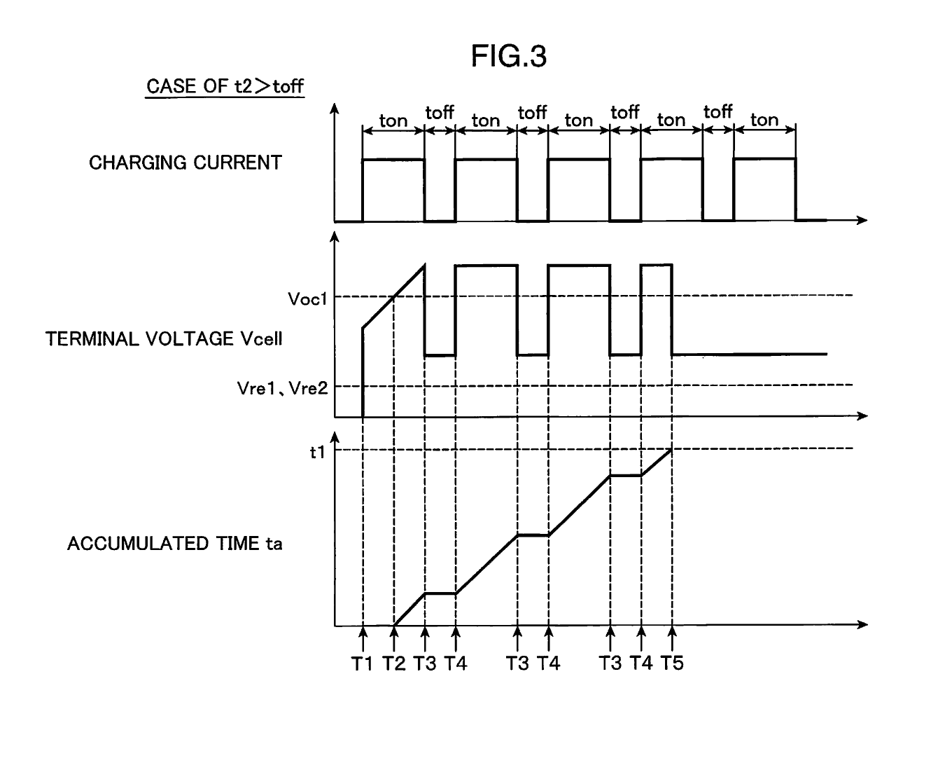

First, the control portion 21 is normally in the normal state S1 in which charging and discharging of the secondary battery is possible. FIG. 3 is a waveform diagram used to explain operation of a battery protection circuit 2 in a case in which pulse charging by a charging portion 102, connected to connection terminals 11 and 12. The horizontal axis in FIG. 3 shows the passage of time. Shown in order from the top are the charging current supplied to the secondary battery 3, the terminal voltage Vcell of the secondary battery 3, and the accumulated time ta which is the accumulated value of the time interval during which the terminal voltage Vcell exceeds the first overcharge detection voltage Voc1.

First, at time T1, supply of a pulse-form charging current from the charging portion 102 to the secondary battery 3 via the connection terminals 11 and 12 is begun. In FIG. 3, the charging time during which a charging current is flowing is shown as ton, and the charging stopped time during which the charging current is stopped is shown as toff. And, as the secondary battery 3 is charged by the pulse-form charging current, the terminal voltage Vcell gradually rises. FIG. 3 shows operation for a case in which the second reference time t2>charging stopped time toff.

The charging portion 102 may be configured such that the charging time ton and charging stopped time toff are made constant, or may be configured such that as charging progresses the charging time ton is made shorter, the charging stopped time toff is made longer, and the duty ratio is reduced.

And, when the terminal voltage Vcell detected by the voltage detection portion 22 exceeds, as the voltage at which charging of the secondary battery 3 is to be prohibited, the first overcharge detection voltage Voc1 set in advance to, for example, 4.3 V (time T2), the control portion 21 transitions to the judgment execution state S2. And, the control portion 21 uses the timer circuit 23 to begin accumulation of times in which the terminal voltage Vcell exceeds the first overcharge detection voltage Voc1, and the accumulated time ta which is the accumulated value thereof increases.

And when, before the accumulated time ta reaches the first reference time t1, the charging time ton has elapsed from the time T1, the charging current goes to zero. Then, the voltage drop occurring due to a charging current flowing in the internal resistance of the secondary battery 3 goes to zero, and the terminal voltage Vcell detected by the voltage detection portion 22 declines and falls below the first overcharge detection voltage Voc1 (time T3). As the first reference time t1, a time longer than the time in ordinary pulse charging during which pulse charging is executed in a state in which the peak voltage of the terminal voltage Vcell rises above the first overcharge detection voltage Voc1, such as for example approximately 5 seconds, is set in advance.

Here, for the secondary battery 3 in a state of charge in which the terminal voltage Vcell when a charging current is flowing becomes the first overcharge detection voltage Voc1, a voltage lower than the open-circuit voltage which is the terminal voltage Vcell when the charge/discharge current is zero, for example 4.1 V, is set in advance as a judgment cancellation voltage Vre2.

Hence when at time T2 the terminal voltage Vcell exceeds the first overcharge detection voltage Voc1 accompanying increases in the SOC (State of Charge) of the secondary battery 3, even if the charge/discharge current goes to zero at time T3, the terminal voltage Vcell does not become equal to or less than the judgment cancellation voltage Vre2. Hence the control portion 21 maintains the judgment execution state S2 without transitioning to the normal state 51 at time T3, and the accumulated time to is maintained without change.

On the other hand, when at time T2 the terminal voltage Vcell instantaneously exceeds the first overcharge detection voltage Voc1 due for example to noise, despite the fact that the secondary battery 3 has not reached a SOC correspond to the first overcharge detection voltage Voc1, when the noise disappears the terminal voltage Vcell falls below the judgment cancellation voltage Vre2. And, when the time during which the terminal voltage Vcell detected by the voltage detection portion 22 is below the judgment cancellation voltage Vre2 exceeds the second reference time t2, the control portion 21 transitions to the normal state 51.

As the second reference time t2, a time approximately sufficient to enable elimination of noise, such as for example approximately 1 second, is set in advance. By this means, when there is an erroneous transition to the judgment execution state S2 due to noise, in the judgment execution state S2 the concern that the time during which the terminal voltage Vcell exceeds the first overcharge detection voltage Voc1 due to noise is accumulated and a transition to the first charging prohibition state S3 may occur is reduced.

Further, in the judgment execution state S2, when the time during which the terminal voltage Vcell is below the judgment cancellation voltage Vre2 continues and exceeds the second reference time t2, there is a transition to the normal state S1, so that the concern, that an erroneous transition to the normal state S1 may occur when an instantaneous fall of the terminal voltage Vcell below the judgment cancellation voltage Vre2 may occur due to noise, is reduced.

Next, in the judgment execution state S2, when the charging stopped time toff has elapsed from the time T3, a charging current again flows to the secondary battery 3 and the terminal voltage Vcell exceeds the first overcharge detection voltage Voc1 (time T4). Then, the timer circuit 23 executes accumulation of the time during which the terminal voltage Vcell exceeds the first overcharge detection voltage Voc1, and the accumulated time ta increases.

Thereafter, operation similar to that at times T3 and T4 is repeated, and the accumulated time ta increases. And, when the accumulated time ta exceeds the first reference time t1 set in advance, the control portion 21 prohibits charging of the secondary battery 3 by transitioning to the first charging prohibition state S3 and turning off the switching element Q1 (time T5). By this means, the secondary battery can be protected from overcharging even in pulse charging.

An example was described in which, in the first charging prohibition state S3, the control portion 21 prohibits charging of the secondary battery 3 by turning off the switching element Q1; but the control portion 21 may for example stop supply of a charging current by the charging portion 102 and prohibit charging in the first charging prohibition state S3 by transmitting a charging stop request to the charging portion 102.

In the first charging prohibition state S3, even when the switching element Q1 is turned off, the secondary battery 3 can be discharged via the diode D1. And, when for example electric power is supplied from the secondary battery 3 to a load device, not shown, connected to the connection terminals 11 and 12, and the terminal voltage Vcell detected by the voltage detection portion 22 falls below a first prohibition cancellation voltage Vre1 set in advance to for example 4.1 V as a voltage at which there is no concern of overcharging, and the time during which the terminal voltage Vcell is below the first prohibition cancellation voltage Vre1 exceeds the third reference time t3, the control portion 21 transitions to the normal state S1. Upon transition to the normal state S1, the control portion 21 turns on the switching element Q1 and enables charging of the secondary battery 3.

As the third reference time t3, a time approximately sufficient to enable elimination of noise, such as for example approximately 1 second, is set in advance. By this means, when the terminal voltage Vcell falls below the first prohibition cancellation voltage Vre1 due to noise, the concern that an erroneous transition to the normal state S1 may occur, and that the secondary voltage 3 may be charged and become overcharged, is reduced.

In FIG. 3, an example is shown in which the first prohibition cancellation voltage Vre1 and the judgment cancellation voltage Vre2 are set to the same voltage; but the judgment cancellation voltage Vre2 need only be set to a voltage lower than the open-circuit voltage of the secondary battery 3 in the state of charge in which, when a charging current is flowing, the terminal voltage Vcell is equal to the first overcharge detection voltage Voc1, and the judgment cancellation voltage Vre2 may be a voltage value equal to or greater than the first prohibition cancellation voltage Vre1.

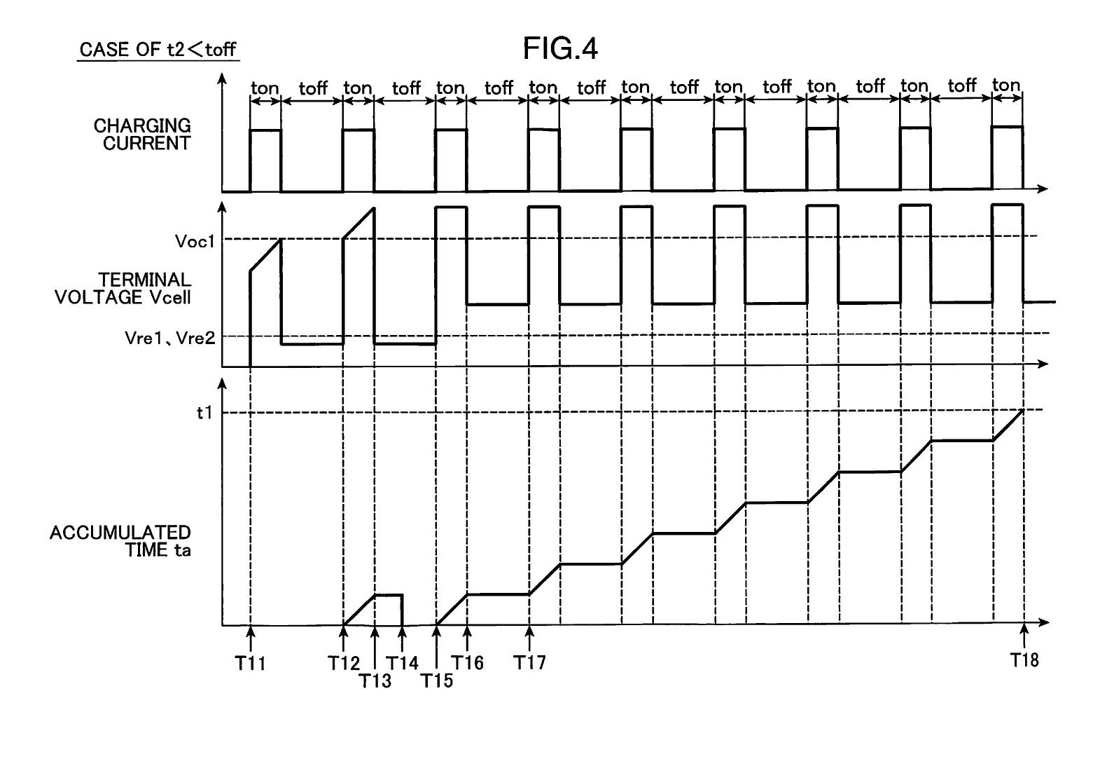

Next, operation of the battery protection circuit 2 when the second reference time t2<the charging stopped time toff is explained, referring to FIG. 4. First, at time T11, supply of a pulse-form charging current from the charging portion 102 via the connection terminals 11 and 12 to the secondary battery 3 is begun. And, as the secondary battery 3 is charged by the pulse-form charging current, the terminal voltage Vcell gradually rises.

And, when the terminal voltage Vcell detected by the voltage detection portion 22 exceeds the first overcharge detection voltage Voc1 (time T12), the control portion 21 transitions to the judgment execution state S2. And, the control portion 21 uses the timer circuit 23 to begin accumulation of the time during which the terminal voltage Vcell exceeds the first overcharge detection voltage Voc1, and the value of the accumulated time ta increases. Suppose that at time T12, although the terminal voltage Vcell instantaneously exceeds the first overcharge detection voltage Voc1, the secondary battery 3 is still charged to a SOC correspond to the first overcharge detection voltage Voc1.

And, when the charging time ton has elapsed from the time T12 the charging current goes to zero. Then, the terminal voltage Vcell detected by the voltage detection portion 22 declines and falls below the judgment cancellation voltage Vre2 (time T13). Here, the second reference time t2<the charging stopped time toff, so that before supply of a charging current is again begun, the second reference time t2 elapses (time T14). Then, the control portion 21 transitions to the normal state S1, and the value of the accumulated time ta is initialized.

Next, at time T15 supply of a charging current to the secondary battery 3 is again begun, the SOC increases until the secondary battery 3 enters an overcharged state, and the terminal voltage Vcell exceeds the first overcharge detection voltage Voc1 (time T15). Then, the control portion 21 transitions to the judgment execution state S2. And, the control portion 21 uses the timer circuit 23 to begin accumulation of the time during which the terminal voltage Vcell exceeds the first overcharge detection voltage Voc1, and the value of the accumulated time ta increases.

And, the charging time ton elapses from the time T15 and the charging current goes to zero. Then, the terminal voltage Vcell detected by the voltage detection portion 22 declines. At this time, the secondary battery 3 is charged to an SOC correspond to the first overcharge detection voltage Voc1, so that the terminal voltage Vcell exceeds the judgment cancellation voltage Vre2 (time T16). Hence the control portion 21 maintains the judgment execution state S2 without transitioning to the normal state S1 at time T16, and the accumulated time ta is maintained without change.

Next, at the judgment execution time S2, when the charging stopped time toff has elapsed from the time T16, a charging current again flows to the secondary battery 3, and the terminal voltage Vcell exceeds the first overcharge detection voltage Voc1 (time T17). Then, the control portion 21 uses the timer circuit 23 to execution accumulation of the time during which the terminal voltage Vcell exceeds the first overcharge detection voltage Voc1, and the accumulated time ta increases.

Thereafter, operation similar to that at times T16 and T17 is repeated, and the accumulated time ta increases. And, when the accumulated time ta exceeds the first reference time t1, the control portion 21 prohibits charging of the secondary battery 3 by transitioning to the first charging prohibition state S3 and turning off the switching element Q1 (time T18). By this means, in pulse charging, even in cases when the second reference time t2<the charging stopped time toff, pulse charging is prohibited, and the secondary battery 3 can be protected from overcharging.

Next, the advantageous effects of setting the judgment cancellation voltage Vre2 to a voltage lower than the first overcharge detection voltage Voc1, or more specifically, to a voltage lower than the open-circuit voltage of the secondary battery 3 in the state of charge in which the terminal voltage during charging is the first overcharge detection voltage Voc1, are explained.

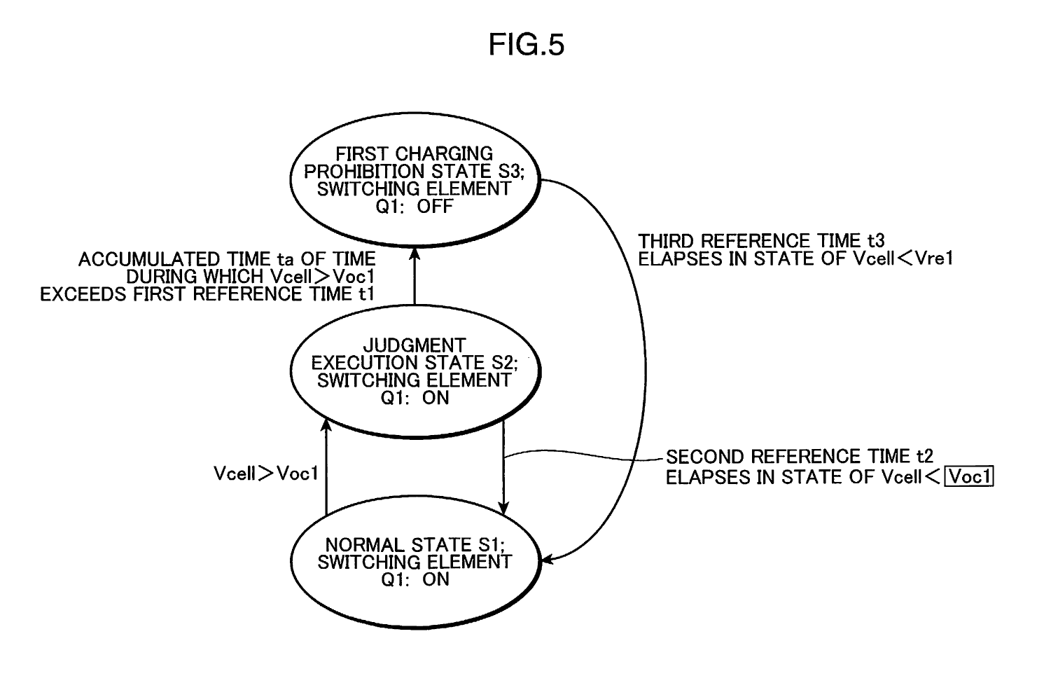

FIG. 5 is a state transition diagram showing when, in the state transition diagram shown in FIG. 2, the condition for transition from the judgment execution state S2 to the first charging prohibition state S3 is tentatively set to “the case in which the time during which the terminal voltage Vcell is continuously below the first overcharge detection voltage Voc1 exceeds the second reference time t2”. According to the state transition diagram shown in FIG. 5, first, when the second reference time t2>the charging stopped time toff, operation similar to that of FIG. 3 is performed, and the secondary battery 3 can be protected from overcharging.

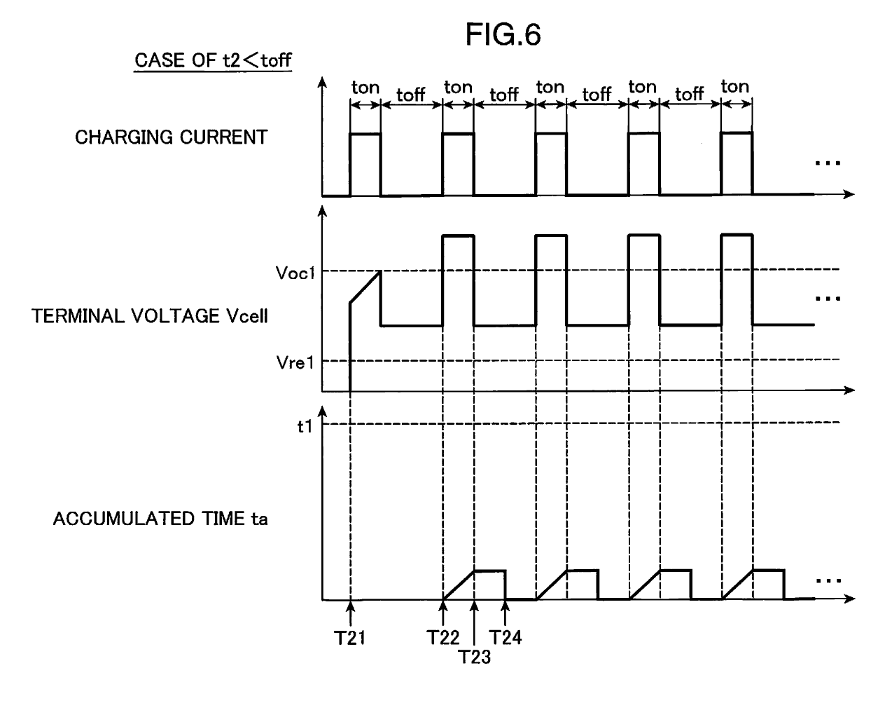

On the other hand, when the second reference time t2<the charging stopped time toff, according to the state transition diagram shown in FIG. 5, operation similar to that shown in FIG. 6 is performed. First, at time T21 a pulse-form charging current begins to be supplied to the secondary battery 3 from a charging circuit, not shown, via the connection terminals 11 and 12. And, as the secondary battery 3 is charged by the pulse-form charging current, the terminal voltage Vcell gradually rises.

And, when the terminal voltage Vcell detected by the voltage detection portion 22 exceeds the first overcharge detection voltage Voc1 (time T22), the control portion 21 transitions to the judgment execution state S2. And, the control portion 21 uses the timer circuit 23 to begin accumulation of the time during which the terminal voltage Vcell exceeds the first overcharge detection voltage Voc1, and the accumulated time ta increases.

And, before the accumulated time ta reaches the first reference time t1, when the charging time ton has elapsed from the time T22, the charging current goes to zero. Then, the voltage drop occurring due to a charging current flowing in the internal resistance of the secondary battery 3 goes to zero, and the terminal voltage Vcell detected by the voltage detection portion 22 declines and falls below the first overcharge detection voltage Voc1 (time T23).

Then, because the second reference time t2<the charging stopped time toff, before the charging stopped time toff has elapsed from the time T23, the second reference time t2 always elapses with the terminal voltage Vcell remaining below the first overcharge detection voltage Voc1, and the control portion 21 transitions to the normal state S1 and the accumulated time ta is initialized (time T24).

Thereafter, operation similar to that at times T22 to T24 is repeated, and pulse charging is continued without the accumulated time ta reaching the first reference time t1. Hence according to the state transition diagram shown in FIG. 6, in a case in which the second reference time t2<the charging stopped time toff, the secondary battery 3 cannot be protected from overcharging.

However, as shown in FIG. 4, by means of the control portion 21 conforming to the state transition diagram shown in FIG. 2, even in a case in which the second reference time t2<the charging stopped time toff, pulse charging is prohibited at time T18, and the secondary battery 3 can be protected from overcharging.

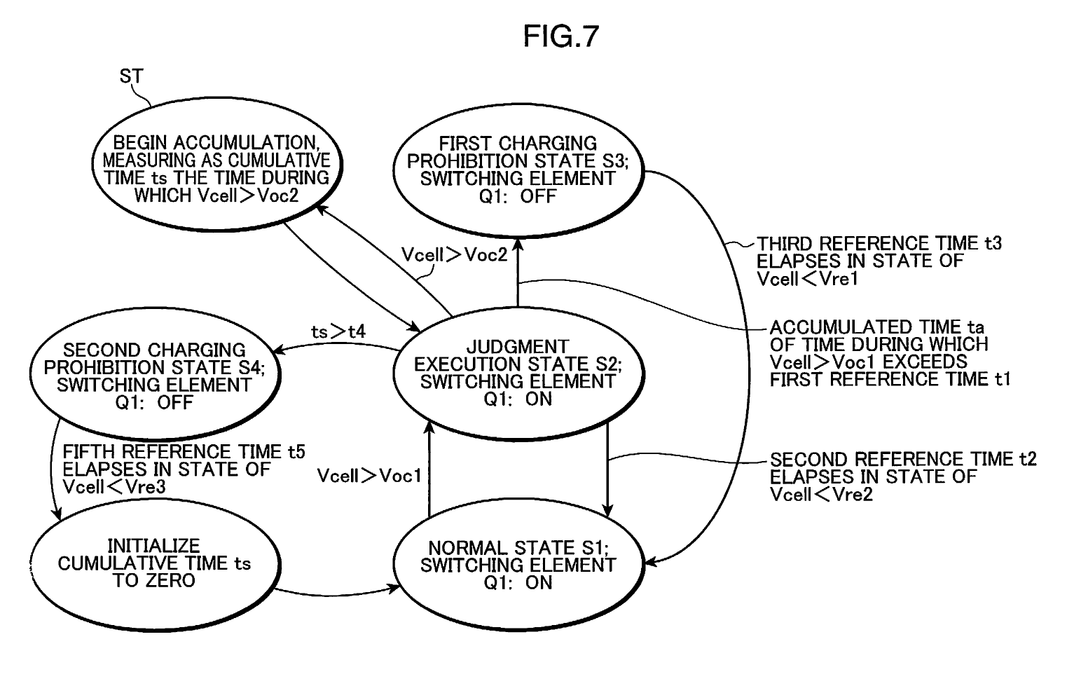

Next, operation and advantageous results are explained in a case in which the control portion 21 has a second charging prohibition state S4. FIG. 7 is a state transition diagram showing an example of operation in a case in which the control portion 21 includes a second charging prohibition state S4.

Here, when in the state transition diagram shown in FIG. 7 the internal resistance value of the secondary battery 3 is normal, operation similar to that of FIG. 2, FIG. 3 and FIG. 4 is performed, without a state transition to the second charging prohibition state S4. However, in a case in which some anomaly occurs in the secondary battery 3 and the internal resistance value of the secondary battery 3 is greater than a normal value, when pulse charging is performed by the charging portion 102, if the charging stopped time toff is longer than the second reference time t2, there is the concern that state transitions between the normal state S1 and the judgment execution state S2 may be repeated, and that pulse charging may be continued in the overcharged state.

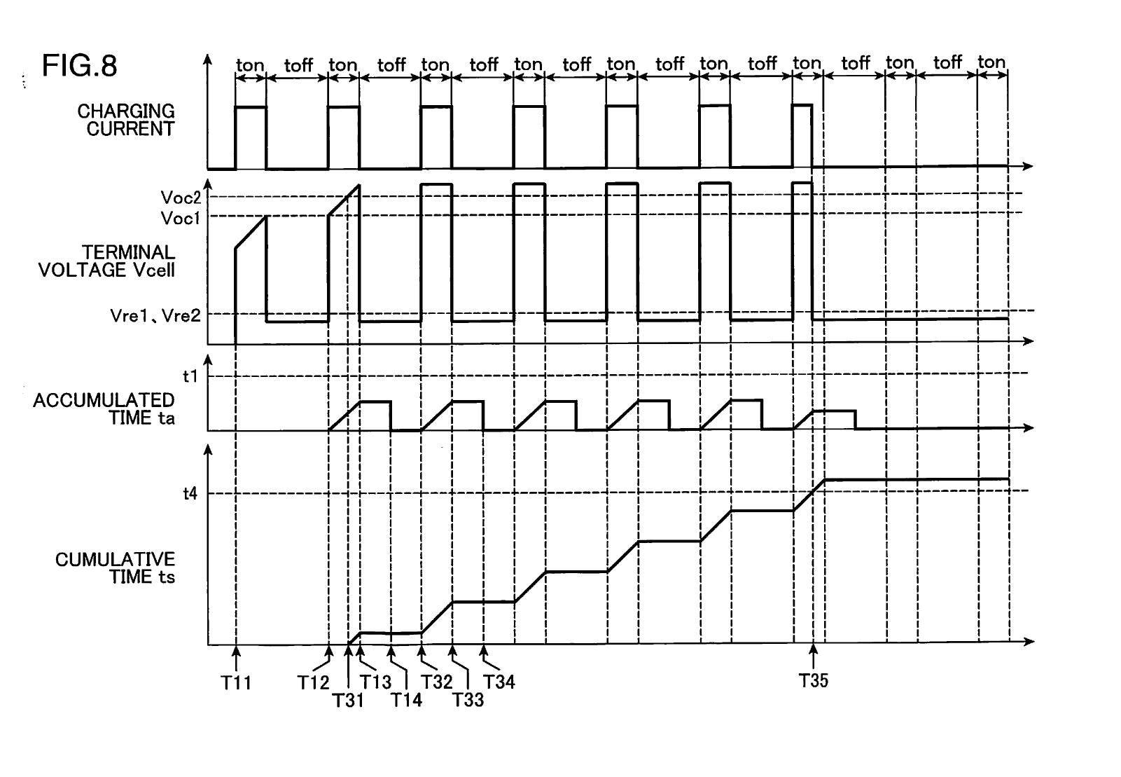

Hence in order to prohibit pulse charging in such a case, a second charging prohibition state S4 is provided. Below, FIG. 7 and FIG. 8 are used to explain operation of the battery protection circuit 2 in a case in which the internal resistance value of the secondary battery 3 is increased to greater than a normal value, when the charging stopped time toff is longer than the second reference time t2. When the charging stopped time toff is shorter than the second reference time t2, operation is similar to that in FIG. 3 except for the fact that during a time interval of a charging stopped time toff in FIG. 3, the terminal voltage Vcell is below the judgment cancellation voltage Vre2, and so an explanation thereof is omitted.

First, at time T11 supply of a pulse-form charging current from the charging portion 102 to the secondary battery 3 via the connection terminals 11 and 12 is begun. And, as the secondary battery 3 is charged by the pulse-form charging current, the terminal voltage Vcell gradually rises.

And, when the terminal voltage Vcell detected by the voltage detection portion 22 exceeds the first overcharge detection voltage Voc1 (time T12), the control portion 21 transitions to the judgment execution state S2. And, the control portion 21 uses the timer circuit 23 to begin accumulation of the time during which the terminal voltage Vcell exceeds the first overcharge detection current Voc1, and the accumulated time to increases.

And, in a case in which the terminal voltage Vcell detected by the voltage detection portion 22 exceeds a voltage higher than the first overcharge detection voltage Voc1, such as for example a second overcharge detection voltage Voc2 set in advance to 4.35 V (time T31), the control portion 21 uses the timer circuit 23, for example, and begins measurement of the cumulative time ts which is the accumulated value of the time during which Vcell>Voc2 (state ST), and thereafter, in each of the states S1 to S3, the time during which the terminal voltage Vcell exceeds the second overcharge detection voltage Voc2 is accumulated and measurement of the cumulative time ts is continued.

In FIG. 8, in order to simplify the explanation, the terminal voltage Vcell is shown as exceeding the second overcharge detection voltage Voc2 immediately after (at time T31) the time when the terminal voltage Vcell exceeds the first overcharge detection voltage Voc1 (time T12); however, the second overcharge detection voltage Voc2 is set to a voltage value higher than the first overcharge detection voltage Voc1 such that, if the internal resistance value of the secondary battery 3 is normal, there is a transition to the first charging prohibition state S3 and the switching element Q1 is turned off before the terminal voltage Vcell exceeds the second overcharge detection voltage Voc2 even when pulse charging is continued.

That is, if the internal resistance value of the secondary battery 3 is normal, the terminal voltage Vcell never exceeds the second overcharge detection voltage Voc2.

And, the charging time ton elapses from the time T12 and the charging current goes to zero (time T13). Then, the voltage arising due to a charging current flowing in the secondary battery 3 goes to zero, and the terminal voltage Vcell declines.

Here, the judgment cancellation voltage Vre2 is set in advance to be a voltage lower than the open-circuit voltage which is the terminal voltage Vcell when the charging current is made zero of the secondary battery 3 in the state of charge in which the terminal voltage Vcell when a charging current is flowing in the secondary battery 3 is the first overcharge detection voltage Voc1. Hence if the secondary battery 3 is normal, even when the terminal voltage Vcell falls to approximately the open-circuit voltage, the terminal voltage Vcell should never fall below the judgment cancellation voltage Vre2.

However, in a case in which some anomaly occurs in the secondary battery 3 and the internal resistance value of the secondary battery 3 increases to a value greater than a normal value, the decline in the terminal voltage Vcell when the charging current goes to zero (time T13) is greater than normal. Then, when the charging current has gone to zero, the terminal voltage Vcell detected by the voltage detection portion 22 declines more than normal, and falls below the judgment cancellation voltage Vre2 (time T13).

Here, the second reference time t2<the charging stopped time toff, so that the second reference time t2 has elapsed before the supply of a charging current is again begun (time T14). Then, the control portion 21 transitions to the normal state S1, and the accumulated time ta is initialized.

Next, supply of a charging current to the secondary battery 3 is again begun at time T32, and the terminal voltage Vcell exceeds the second overcharge detection voltage Voc2 (time T32). Then, the control portion 21 transitions to the judgment execution state S2. And, the control portion 21 uses the timer circuit 23 to begin, from zero, accumulation of the time during which the terminal voltage Vcell exceeds the first overcharge detection voltage Voc1, and the accumulated time ta increases. At this time, the control portion 21 uses the timer circuit 23 to accumulate, as the cumulative time ts, the time during which the terminal voltage Vcell exceeds the second overcharge detection voltage Voc2.

And, the charging time ton elapses from the time T32 and the charging current goes to zero. Then, the terminal voltage Vcell detected by the voltage detection portion 22 again falls below the judgment cancellation voltage Vre2 (time T33), and the second reference time t2 again elapses (time T34). Then, the control portion 21 transitions to the normal state S1, and the accumulated time ta is initialized.

Thereafter, operation similar to that at times T32 to T34 is repeated, and the accumulated time ta is initialized without reaching the first reference time t1, so that pulse charging is continued without a transition to the first charging prohibition state S3.

However, in the process of repeating operation similar to that at times T32 to T34, the accumulation of the cumulative time ts is continued cumulatively, and the cumulative time ts gradually increases. And, when the cumulative time ts exceeds the fourth reference time t4 (time T35), the control portion 21 transitions to the second charging prohibition state S4, turns off the switching element Q1, and prohibits charging of the secondary battery 3 (time T35).

By this means, the battery protection circuit 2 can prohibit pulse charging and protect the secondary battery 3 from overcharging even when some anomaly occurs in the secondary battery 3 and the internal resistance value of the secondary battery 3 increased to greater than a normal value.

As the fourth reference time t4, a time approximately sufficient to enable elimination of noise, such as for example approximately 1 second, is set in advance. By this means, when the terminal voltage Vcell instantaneously rises above the second overcharge detection voltage Voc2 due to noise, the concern of erroneous transition to the second charging prohibition state S4 and prohibition of charging of the secondary battery 3 is reduced.

Here, the switching element Q2 is turned on, and the secondary battery 3 is capable of discharge. Hence in the second charging prohibition state S4, when for example the secondary battery 3 is discharged and electric power is supplied to a load device, not shown, and a state in which the terminal voltage Vcell detected by the voltage detection portion 22 is below the second prohibition cancellation voltage Vre3 set in advance to a voltage value equal to or less than the judgment cancellation voltage Vre2 continues for the time interval of the fifth reference time set in advance, the control portion 21 initializes the cumulative time ts to zero, transitions to the normal state S1, causes the switching element Q1 to be turned on, and enables charging of the secondary battery 3.

As the fifth reference time t5, a time approximately sufficient to enable elimination of noise, such as for example approximately 1 second, is set in advance. By this means, when the terminal voltage Vcell instantaneously falls below the second prohibition cancellation voltage Vre3 due to noise, the concern of erroneous transition to the normal state S1 and of charging and overcharging of the secondary battery 3 is reduced.

As explained above, when the internal resistance value of the secondary battery 3 is normal, the terminal voltage Vcell never exceeds the second overcharge detection voltage Voc2, and so when the terminal voltage Vcell exceeds the second overcharge detection voltage Voc2, it is thought that some anomaly is occurring. Hence a configuration may be employed in which accumulation of the cumulative time ts is not performed, and when in the judgment execution state S2 the terminal voltage Vcell exceeds the second overcharge detection voltage Voc2, there is a rapid transition to the second charging prohibition state S4.

Further, a configuration may be employed in which, when in the judgment execution state S2 the terminal voltage Vcell falls below the judgment cancellation voltage Vre2, there is a rapid transition to the normal state S1 without waiting for the second reference time t2 to elapse. Further, a configuration may be employed in which, when in the first charging prohibition state S3 the terminal voltage Vcell falls below the first prohibition cancellation voltage Vre1, there is a rapid transition to the normal state S1 without waiting for the third reference time t3 to elapse. Further, a configuration may be employed in which, when in the second charging prohibition state S4 the terminal voltage Vcell falls below the second prohibition cancellation voltage Vre3, there is a rapid transition to the normal state S1 without waiting for the fifth reference time t5 to elapse.

A configuration may be employed in which a voltage detection portion which detects the terminal voltage of a secondary battery, and a control portion having a normal state in which the secondary battery can be charged, a judgment execution state in which judgement as to whether the secondary battery is in an overcharged state is performed, and first and second charging prohibition states in which charging of the secondary battery is prohibited, are comprised; in the normal state, when the terminal voltage detected by the voltage detection portion exceeds a first overcharge detection voltage set in advance as a voltage at which charging of the secondary battery is to be prohibited, the control portion transitions to the judgment execution state; in the judgment execution state, when the accumulated value after entering the judgment execution state of the time interval during which the terminal voltage detected by the voltage detection portion exceeds the first overcharge detection voltage exceeds a first reference time set in advance, the control portion transitions to the first charging prohibition state and prohibits charging of the secondary battery; in the judgment execution state, when the terminal voltage detected by the voltage detection portion falls below a judgment cancellation voltage lower than the first overcharge detection voltage, the control portion transitions to the normal state and enables charging of the secondary battery; and in the judgment execution state, when the terminal voltage detected by the voltage detection portion exceeds a second overcharge detection voltage set in advance to a voltage higher than the first overcharge detection voltage, the control portion transitions to the second charging prohibition state and prohibits charging of the secondary battery.

That is, the overcharge protection circuit according to one aspect of the invention includes: a voltage detection portion which detects a terminal voltage of a secondary battery; and a control portion, having a normal state in which the secondary battery can be charged, a judgment execution state in which judgement as to whether the secondary battery is in an overcharged state is performed, and a first charging prohibition state in which charging of the secondary battery is prohibited, wherein in the normal state, when a terminal voltage detected by the voltage detection portion exceeds a first overcharge detection voltage set in advance as a voltage at which charging of the secondary battery is to be prohibited, the control portion transitions to the judgment execution state, in the judgment execution state, when an accumulated value, after the judgment execution state is established, of a time interval during which the terminal voltage detected by the voltage detection portion exceeds the first overcharge detection voltage, exceeds a first reference time set in advance, the control portion transitions to the first charging prohibition state, and in the judgment execution state, when the terminal voltage detected by the voltage detection portion falls below a judgment cancellation voltage lower than the first overcharge detection voltage, the control portion transitions to the normal state and enables charging of the secondary battery.

By means of this configuration, in addition to a normal state in which the secondary battery can be charged and a first charging prohibition state in which charging of the secondary battery is prohibited, the control portion can enter a judgment execution state in which judgment as to whether the secondary battery is in an overcharged state is executed. And, when in the normal state the terminal voltage of the secondary battery exceeds the first overcharge detection voltage, the control portion transitions to the judgment execution state. Upon entering the judgment execution state, so long as the terminal voltage of the secondary battery does not fall below the judgment cancellation voltage lower than the first overcharge detection voltage, the control portion does not transition to the normal state, so that even if a charging pulse is turned off in pulse charging, the judgment execution state is maintained. And, even if the charging pulse of pulse charging is repeatedly turned on and off, while the judgment execution state is maintained, the time interval during which the terminal voltage of the secondary battery exceeds the first overcharge detection voltage is accumulated, so that when pulse charging is continued the accumulated value increases, and at some time exceeds the first reference time. Then, the control portion transitions to the first charging prohibition state and prohibits charging of the secondary battery, so that even in pulse charging, the concern that the secondary battery cannot be protected from overcharging can be reduced.

Further, as the judgment cancellation voltage, it is preferable that a voltage, lower than an open-circuit voltage of the secondary battery in a state of charge in which the terminal voltage during charging is equal to the first overcharge detection voltage, is set in advance.

The terminal voltage of the secondary battery includes a voltage rise portion occurring due to the internal resistance of the secondary battery during charging when a charging current flows, and so is a higher voltage than the open-circuit voltage. In the secondary battery in a state of being charged until this terminal voltage during charging has reached the first overcharge detection voltage, when a voltage lower than the open-circuit voltage when the charging current is made zero is set as the judgment cancellation voltage, even if the charging pulse in pulse charging is turned off in the judgment execution state, so long as the internal resistance is normal the terminal voltage of the secondary battery never falls below the judgment cancellation voltage. Hence when the charging pulse is turned off, the judgment execution state can be reliably maintained, so that accumulation of the time interval during which the terminal voltage of the secondary battery exceeds the first overcharge detection voltage can be continued, and as a result the reliability with which the secondary battery is protected from overcharging improves even in pulse charging.

Further, it is preferable that when, in the judgment execution state, the terminal voltage detected by the voltage detection portion falls below the judgment cancellation voltage lower than the overcharge detection voltage and the state in which the terminal voltage is below the judgment cancellation voltage continues for a period of a second reference time set in advance, the control portion transition to the normal state and enable charging of the secondary battery.

By means of this configuration, even when in the judgment execution state the charging pulse is turned off and the terminal voltage of the secondary battery instantaneously falls below the judgment cancellation voltage due to the effect of noise, so long as this low voltage does not continue for the period of the second reference time, the judgment execution state is maintained. As a result, the concern that a transition to the normal state may occur due to noise is reduced, and the reliability with which accumulation of the time interval during which the terminal voltage of the secondary battery exceeds the first overcharge detection voltage is continued is improved, so that the reliability of protection of the secondary battery from overcharging is improved.

Further, it is preferable that when, in the first charging prohibition state, the terminal voltage detected by the voltage detection portion is continuously below a first prohibition cancellation voltage equal to or less than the judgment cancellation voltage during a period of a third reference time set in advance, the control portion transition to the normal state and enable charging of the secondary battery.

By means of this configuration, when in the first charging prohibition state the terminal voltage declines, for example when the secondary battery is discharged, and the terminal voltage is continuously below the first prohibition cancellation voltage for the period of the third reference time, it is thought that the overcharged state of the secondary battery has been resolved, and so the control portion transitions to the normal state and enables charging of the secondary battery. By this means, even when charging of a secondary battery has once been prohibited, if the overcharged state is resolved, charging is again enabled.

Further, it is preferable that the control portion further have a second charging prohibition state in which charging of the secondary battery is prohibited, and when, in the judgment execution state, the terminal voltage detected by the voltage detection portion exceeds a second overcharge detection voltage set in advance to a voltage higher than the first overcharge detection voltage, the control portion transition to the second charging prohibition state and prohibit charging of the secondary battery.

By means of this configuration, the control portion can enter, as a prohibition state in which charging of the secondary battery is prohibited, a second charging prohibition state transition conditions for which are different from those for the first charging prohibition state. Here, even when the control portion transitions to the first charging prohibition state and prohibits charging of the secondary battery, when in a state in which the internal resistance value of the secondary battery is greater than a normal value, the amount of decline in the terminal voltage when the charging pulse in pulse charging is turned off is larger than normal, the terminal voltage falls below the judgment cancellation voltage, and the control portion transitions to the normal state. Then, when there is again a transition to the judgment execution state, accumulation of the time interval during which the terminal voltage exceeds the first overcharge detection voltage is performed anew, so that state transitions between the normal state and the judgment execution state occur repeatedly, and pulse charging continues without being prohibited. However, by means of this configuration, when pulse charging is continued and the terminal voltage of the secondary battery rises to exceed the first overcharge detection voltage, and the terminal voltage of the secondary battery exceeds the second overcharge detection voltage, the control portion transitions to the second charging prohibition state and prohibits charging of the secondary battery, so that even in a state in which the internal resistance value of the secondary battery is greater than normal, the concern that the secondary battery cannot be protected from overcharging by pulse charging can be reduced.

Further, it is preferable that when, in the judgment execution state, the terminal voltage detected by the voltage detection portion exceeds the second overcharge detection voltage, the control portion begin measurement of a cumulative time which is the accumulated value of the time during which the terminal voltage exceeds the second overcharge detection voltage, thereafter in each of the states, continues measurement of the cumulative time by accumulating the time during which the terminal voltage exceeds the second overcharge detection voltage, and when, in the judgment execution state, the terminal voltage detected by the voltage detection portion exceeds the second overcharge detection voltage and the accumulated cumulative time exceeds a fourth reference time set in advance, the control portion transition to the second charging prohibition state and prohibit charging of the secondary battery.

By means of this configuration, even when in the judgment execution state the terminal voltage of the secondary battery instantaneously exceeds the second overcharge detection voltage due to the effect of noise, if the cumulative time does not exceed the fourth reference time the control portion does not transition to the second charging prohibition state, so that the concern that charging of the secondary battery may be erroneously prohibited due to noise is reduced. Further, if the terminal voltage of the secondary battery exceeds the second overcharge detection voltage, in each of the states thereafter the time during which the terminal voltage exceeds the second overcharge detection voltage is continuously accumulated and the cumulative time is measured. Hence even when for example, in a state in which the internal resistance value of the secondary battery is greater than a normal value, and state transitions between the normal state and the judgment execution state occur repeatedly as described above, measurement of the cumulative time is continued. And, when the cumulative time exceeds the fourth reference time, the control portion transitions to the second charging prohibition state and prohibits charging of the secondary battery, so that the concern that the secondary battery cannot be protected from overcharging by pulse charging can be reduced, while reducing the effect of noise.

Further, it is preferable that when, in the second charging prohibition state, the terminal voltage detected by the voltage detection portion falls below a second prohibition cancellation voltage equal to or lower than the judgment cancellation voltage, the control portion transition to the normal state and execute prohibition cancellation processing to enable charging of the secondary battery.

By means of this configuration, when in the second charging prohibition state the terminal voltage declines, for example when the secondary battery is discharged, and the terminal voltage falls below the second prohibition cancellation voltage, it is thought that the overcharged state of the secondary battery has been resolved, and so the control portion transitions to the normal state and enables charging of the secondary battery. By this means, even when charging of a secondary battery has once been prohibited, if the overcharged state is resolved, charging is again enabled.

Further, it is preferable that when, in the second charging prohibition state, the terminal voltage detected by the voltage detection portion falls below the second prohibition cancellation voltage, the accumulated cumulative time be also initialized to zero in the prohibition cancellation processing.

By means of this configuration, when the terminal voltage of the secondary battery falls below the second prohibition cancellation voltage and it is thought that the overcharged state of the secondary battery has been resolved, the cumulative time is initialized to zero and the control portion transitions to the normal state, so that when there is a subsequent transition to the judgment execution state, erroneous occurrence of a transition to the second charging prohibition state based on the cumulative time accumulated in the past is prevented.

Further, it is preferable that when, in the second charging prohibition state, the terminal voltage detected by the voltage detection portion falls below the second prohibition cancellation voltage and the state in which the terminal voltage is below the second prohibition cancellation voltage continues for the period of a fifth reference time set in advance, the control portion execute prohibition cancellation processing.

By means of this configuration, even when in the second charging prohibition state the terminal voltage of the secondary battery instantaneously falls below the second prohibition cancellation voltage due to the effect of noise, so long as this low voltage does not continue for the period of the fifth reference time, the second charging prohibition state is maintained. As a result, the concern that prohibition cancellation processing may be erroneously executed and a transition to the normal state may occur due to noise is reduced.

Further, it is preferable that a switching element for charging, which cuts off a charging current to the secondary battery by turning off, and a switching element for discharging, which cuts off a discharging current from the secondary battery by turning off, be further provided, and that the control portion prohibit charging of the secondary battery by turning off the switching element for charging and turning on the switching element for discharging, and enable charging of the secondary battery by turning on the switching element for charging and turning on the switching element for discharging.

By means of this configuration, in the first and second charging prohibition states, the control portion can prohibit only charging of the secondary battery while remaining in a state in which discharging of the secondary battery is enabled by turning off the switching element for charging and turning on the switching element for discharging, so that in the first and second charging prohibition states, it is easy to discharge the secondary battery and resolve the overcharged state.

Further, it is preferable that when the terminal voltage detected by the voltage detection portion becomes equal to lower than a discharging prohibition voltage set in advance to prevent overdischarge of the secondary battery, the control portion forcibly turn off the switching element for discharging.

By means of this configuration, when the terminal voltage detected by the voltage detection portion becomes equal to or lower than the discharging prohibition voltage set in advance to prevent overdischarge of the secondary battery, the switching element for discharging is turned off by the control portion, and further discharging is prohibited, so that overdischarge of the secondary battery can be prevented.

Further, the battery pack according to one aspect of the invention includes: an overcharge protection circuit described above; and the secondary battery.

By means of this configuration, in a battery pack comprising an overcharge protection circuit, even when pulse charging of the battery pack is performed, the concern that the secondary battery cannot be protected from overcharging can be reduced.

Further, the charging system according to one aspect of the invention includes: an overcharge protection circuit described above; and a charging portion, which performs pulse charging of the secondary battery by periodically supplying, in pulse form, a charging current set in advance.

By means of this configuration, in the charging system comprising a charging portion which performs pulse charging of a secondary battery, the concern that the secondary battery cannot be protected from overcharging can be reduced.

### INDUSTRIAL APPLICABILITY

This invention can be used suitably as an overcharge protection circuit to protect from overcharging a secondary battery which supplies electric power to portable personal computers, digital cameras, portable telephone sets and other electronic equipment, to electric vehicles, hybrid cars and other vehicles and similar, and to various battery-driven equipment, and as a battery pack and charging system comprising such an overcharge protection circuit.

1. An overcharge protection circuit, comprising:
a voltage detection portion which detects a terminal voltage of a secondary battery; and
a control portion, having a normal state in which the secondary battery can be charged, a judgment execution state in which judgement as to whether the secondary battery is in an overcharged state is performed, and a first charging prohibition state in which charging of the secondary battery is prohibited, wherein
in the normal state, when a terminal voltage detected by the voltage detection portion exceeds a first overcharge detection voltage set in advance as a voltage at which charging of the secondary battery is to be prohibited, the control portion transitions to the judgment execution state,
in the judgment execution state, when an accumulated value, after the judgment execution state is established, of a time interval during which the terminal voltage detected by the voltage detection portion exceeds the first overcharge detection voltage, exceeds a first reference time set in advance, the control portion transitions to the first charging prohibition state, and
in the judgment execution state, when the terminal voltage detected by the voltage detection portion falls below a judgment cancellation voltage lower than the first overcharge detection voltage, the control portion transitions to the normal state and enables charging of the secondary battery.

2. The overcharge protection circuit according to claim 1, wherein, as the judgment cancellation voltage, a voltage, lower than an open-circuit voltage of the secondary battery in a state of charge in which the terminal voltage during charging is equal to the first overcharge detection voltage, is set in advance.

3. The overcharge protection circuit according to claim 1, wherein when, in the judgment execution state, the terminal voltage detected by the voltage detection portion falls below the judgment cancellation voltage lower than the overcharge detection voltage and the state in which the terminal voltage is below the judgment cancellation voltage continues for a period of a second reference time set in advance, the control portion transitions to the normal state and enables charging of the secondary battery.

4. The overcharge protection circuit according to claim 1, wherein when, in the first charging prohibition state, the terminal voltage detected by the voltage detection portion is continuously below a first prohibition cancellation voltage equal to or less than the judgment cancellation voltage during a period of a third reference time set in advance, the control portion transitions to the normal state and enables charging of the secondary battery.

5. The overcharge protection circuit according to claim 1, wherein the control portion further has a second charging prohibition state in which charging of the secondary battery is prohibited, and when, in the judgment execution state, the terminal voltage detected by the voltage detection portion exceeds a second overcharge detection voltage set in advance to a voltage higher than the first overcharge detection voltage, the control portion transitions to the second charging prohibition state and prohibits charging of the secondary battery.

6. The overcharge protection circuit according to claim 5, wherein when, in the judgment execution state, the terminal voltage detected by the voltage detection portion exceeds the second overcharge detection voltage, the control portion begins measurement of a cumulative time which is the accumulated value of the time during which the terminal voltage exceeds the second overcharge detection voltage, thereafter in each of the states, continues measurement of the cumulative time by accumulating the time during which the terminal voltage exceeds the second overcharge detection voltage, and
when, in the judgment execution state, the terminal voltage detected by the voltage detection portion exceeds the second overcharge detection voltage and the accumulated cumulative time exceeds a fourth reference time set in advance, the control portion transitions to the second charging prohibition state and prohibits charging of the secondary battery.

7. The overcharge protection circuit according to claim 5, wherein when, in the second charging prohibition state, the terminal voltage detected by the voltage detection portion falls below a second prohibition cancellation voltage equal to or lower than the judgment cancellation voltage, the control portion transitions to the normal state and executes prohibition cancellation processing to enable charging of the secondary battery.

8. The overcharge protection circuit according to claim 7, wherein when, in the second charging prohibition state, the terminal voltage detected by the voltage detection portion fails below the second prohibition cancellation voltage, the control portion also initializes the accumulated cumulative time to zero in the prohibition cancellation processing.

9. The overcharge protection circuit according to claim 7, wherein when, in the second charging prohibition state, the terminal voltage detected by the voltage detection portion falls below the second prohibition cancellation voltage and the state in which the terminal voltage is below the second prohibition cancellation voltage continues for the period of a fifth reference time set in advance, the control portion executes the prohibition cancellation processing.

10. The overcharge protection circuit according to claim 1, further comprising:
a switching element for charging, which cuts off a charging current to the secondary battery by turning off; and
a switching element for discharging, which cuts off a discharging current from the secondary battery by turning off, wherein
the control portion prohibits charging of the secondary battery by turning off the switching element for charging and turning on the switching element for discharging, and enables charging of the secondary battery by turning on the switching element for charging and turning on the switching element for discharging.

11. The overcharge protection circuit according to claim 10, wherein when the terminal voltage detected by the voltage detection portion becomes equal to or lower than a discharging prohibition voltage set in advance to prevent overdischarge of the secondary battery, the control portion forcibly turns off the switching element for discharging.

12. A battery pack, comprising:
the overcharge protection circuit according to claim 1; and the secondary battery.

13. A charging system, comprising:
the overcharge protection circuit according to claim 1; and
a charging portion, which performs pulse charging of the secondary battery by periodically supplying, in pulse form, a charging current set in advance.
